(19) United States
(12) Patent Application Publication
(10) Pub. No.: US 2004/0158805 A1
(43) Pub. Date: Aug. 12, 2004

(54) Parasitic capacitance extracting device and method for semiconductor integrated circuit

(75) Inventors: Toshiki Kanamoto, Tokyo (JP); Hirokazu Ikeda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/603,862

(22) Filed: Jun. 26, 2003

(30) Foreign Application Priority Data
Feb. 7, 2003 (JP) 2003-030376

(51) Int. Cl. G06F 17/50; G06F 9/455

(52) U.S. Cl. 716/11; 716/8; 716/12

(57) ABSTRACT

An electromagnetic field analyzer (11) finally replaces a fill metal pattern in a wiring pattern library (32) with an insulator of high dielectric constant, and stores, in a capacitance value data base (33), parasitic capacitance value information in which values of parasitic capacitances parasiting the insulator and fill metal patterns are in correspondence. A regression analyzer (12) stores, in a regression equation data base (36), regression equation information for deriving parasitic capacitance values from the fill metal patterns and associated size information. A parasitic capacitance extractor (13) obtains values of parasitic capacitances parasiting the replacing insulator for outputting parasitic capacitance information (37) while applying a regression equation of the regression equation information to the size information associated with the fill metal patterns.

### BACKGROUND OF THE INVENTION

1. Field of the Invention

The present invention relates to a parasitic capacitance extracting method for a semiconductor integrated circuit. More particularly, it relates to a parasitic capacitance extracting device and a parasitic capacitance extracting method for a semiconductor integrated circuit having dummy interconnect lines (hereinafter referred to as “fill metals”).

2. Description of the Background Art

Among methods of extracting parasitic capacitances of a semiconductor integrated circuit having fill metals is a method disclosed in Japanese Patent Application Laid-Open No. 2002-149739. This method includes the steps of: calculating the density of interconnect lines in a layout of a semiconductor integrated circuit; comparing the density of interconnect lines with that of dummy interconnect lines provided in an interconnect line region of the semiconductor integrated circuit; judging whether or not the interconnect line region in which the interconnect line density has been calculated is an interconnect line region in which the dummy interconnect lines are to be provided; with respect to the interconnect line region which has been judged that the dummy interconnect lines are to be provided therein, estimating a circuit layout for the case where the dummy interconnect lines are provided; and extracting parasitic capacitances from the semiconductor integrated circuit layout including the estimated circuit layout.

Since conventional methods of extracting parasitic capacitances of a semiconductor integrated circuit are carried out as described above, the following disadvantages (1) and (2) arise.

(1) In the case where parasitic capacitances are extracted from a layout in which fill metals are inserted, the number of nodes and that of devices in a circuit network increase, causing circuit analysis time to be prolonged.

(2) In the case where fill metals are inserted in a semiconductor integrated circuit, high resistances are inserted between nodes of the fill metals and a ground level during extraction of the fill metals or during preprocessing performed before circuit analysis, to thereby enable circuit analysis. However, inflow and outflow of charges at the fill metals which actually do not exist degrades the accuracy of transient analysis.

### SUMMARY OF THE INVENTION

It is an object of the present invention to provide a parasitic capacitance extracting device and a parasitic capacitance extracting method for a semiconductor integrated circuit having fill metals, intended for shortening circuit analysis time while maintaining the accuracy of circuit analysis.

According to a first aspect of the present invention, the parasitic capacitance extracting device for a semiconductor integrated circuit includes a parasitic capacitance value information calculator and a parasitic capacitance extractor. The parasitic capacitance value information calculator is configured to extract a dummy wiring pattern model from a wiring pattern library specifying wiring patterns of multilayer structure including the dummy wiring pattern model to replace the dummy wiring pattern model with a replacing insulator, thereby obtaining parasitic capacitance value information in which a value of a parasitic capacitance parasiting the replacing insulator is in correspondence with the dummy wiring pattern model, the replacing insulator having a dielectric constant higher than that of an interlayer insulation film isolating a wiring pattern of another layer from the dummy wiring pattern model. The parasitic capacitance extractor is configured to receive layout pattern data specifying a semiconductor integrated circuit from which a parasitic capacitance is to be extracted and an extraction rule for extracting a dummy wiring pattern and to extract the dummy wiring pattern from the layout pattern data, thereby extracting a parasitic capacitance value corresponding to the dummy wiring pattern as extracted based on information related to the parasitic capacitance value information.

The parasitic capacitance value extracted by the parasitic capacitance extractor is a value of a parasitic capacitance parasiting the replacing insulator provided in place of the dummy wiring pattern. This can reduce the number of parasitic capacitances as compared to the case of obtaining a parasitic capacitance value directly from the dummy wiring pattern. For instance, when wiring patterns exist in layers on and under the dummy wiring pattern, respectively, two parasitic capacitances are generated between the dummy wiring pattern and the wiring patterns thereon and thereunder, respectively. However, after replacing the dummy wiring pattern model with the replacing insulator, the number of parasitic capacitances is reduced to one. At this time, the replacing insulator has a dielectric constant defined as higher than that of the interlayer insulation film, whereby the equivalency of parasitic capacitances of the semiconductor integrated circuit before and after the replacement can be maintained. As a result, time for analyzing a parasitic capacitance value can greatly be shortened while maintaining the accuracy of the analysis.

According to a second aspect of the invention, the parasitic capacitance extracting method for a semiconductor integrated circuit includes the following steps (a) to (c). The step (a) is to receive layout pattern data specifying a layout structure of a semiconductor integrated circuit from which a parasitic capacitance is to be extracted, the layout pattern data including a wiring pattern of multilayer structure and a dummy wiring pattern, thereby extracting the dummy wiring pattern from the layout pattern data. The step (b) is to replace the dummy wiring pattern with a replacing insulator, the replacing insulator having a dielectric constant higher than that of an interlayer insulation film isolating a wiring pattern of another layer from the dummy wiring pattern. The step (c) is to extract a value of a parasitic capacitance parasiting the replacing insulator based on a circuit specified by the layout pattern data after replacement with the replacing insulator.

Since the dummy wiring pattern is replaced with the replacing insulator in the step. (b) and a value of a parasitic capacitance parasiting the replacing insulator is extracted in the step (c), the number of parasitic capacitances can be reduced as compared to the case of obtaining a value of a parasitic capacitance directly from the dummy wiring pattern. As a result, time for analyzing a parasitic capacitance value can greatly be shortened while maintaining the accuracy of the analysis.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative example of the state of a parasitic capacitance between a fill metal part and interconnect lines;

FIG. 2 is an illustrative example of fill metal replacement by a parasitic capacitance extracting method for a semiconductor integrated circuit according to a first preferred embodiment of the present invention;

FIG. 3 is a circuit diagram illustrating an equivalent circuit after replacement with a replacing insulator;

FIG. 4 is a circuit diagram illustrating an equivalent circuit formed by parasitic capacitances shown in FIG. 1;

FIG. 5 is a flow chart illustrating the parasitic capacitance extracting method according to the first preferred embodiment;

FIG. 6 is a block diagram illustrating the structure of a parasitic capacitance extracting device for a semiconductor integrated circuit according to a second preferred embodiment of the invention;

FIG. 7 is a flow chart illustrating parasitic capacitance extraction performed by the parasitic capacitance extracting device according to the second preferred embodiment;

FIG. 8 is a block diagram illustrating the structure of a parasitic capacitance extracting device for a semiconductor integrated circuit according to a third preferred embodiment of the invention;

FIG. 9 is a flow chart illustrating parasitic capacitance extraction performed by the parasitic capacitance extracting device according to the third preferred embodiment;

FIG. 10 is a block diagram illustrating the structure of a parasitic capacitance extracting device for a semiconductor integrated circuit according to a fourth preferred embodiment of the invention;

FIG. 11 is a flow chart illustrating parasitic capacitance extraction performed by the parasitic capacitance extracting device according to the fourth preferred embodiment;

FIG. 12 is a block diagram illustrating the structure of a parasitic capacitance extracting device for a semiconductor integrated circuit according to a fifth preferred embodiment of the invention;

FIG. 13 is a flow chart illustrating parasitic capacitance extraction performed by the parasitic capacitance extracting device according to the fifth preferred embodiment;

FIG. 14 is a sectional view illustrating a fill metal multilayer structure;

FIG. 15 is an illustrative example of the state in which parasitic capacitances are formed with the structure shown in FIG. 14;

FIG. 16 is a circuit diagram illustrating an equivalent circuit between wiring elements including the parasitic capacitances shown in FIG. 15; and

FIG. 17 is an illustrative example of resistance interpolation of fill metal elements.

### DESCRIPTION OF THE PREFERRED EMBODIMENTS

Basic Technique

For easier understanding of the present invention, fill metal insertion which is the basic technique will be described first. Fill metal insertion into a semiconductor integrated circuit is performed at a preliminary stage of mask formation for the purpose of making the line density uniform, and the like. A fill metal differs from individual elements in a highly integrated semiconductor integrated circuit and is electrically separated from other elements. The fill metal is parasited by parasitic elements typified by wring capacitance and wiring resistance.

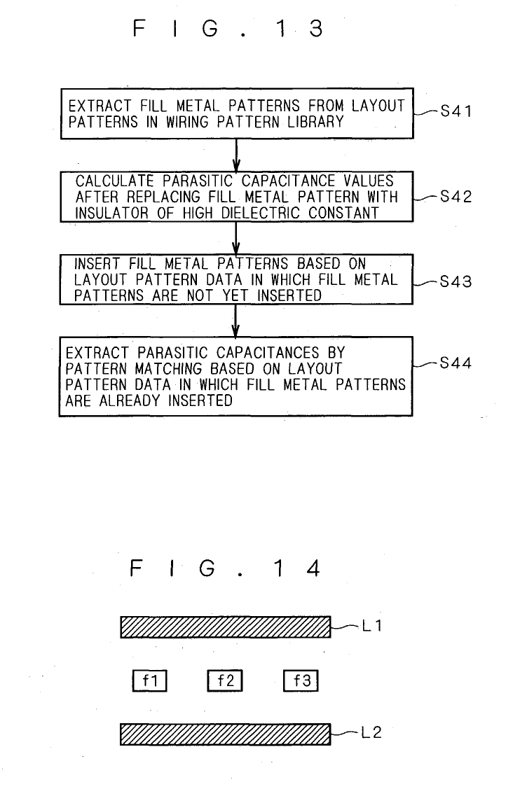

FIG. 14 is a sectional view illustrating a fill metal multilayer structure. This example shows a wiring element L1 as the uppermost layer of the three-layered structure, a wiring element L2 as the lowermost layer and fill metal elements f1 to f3 which are dummy wiring elements as the intermediate layer.

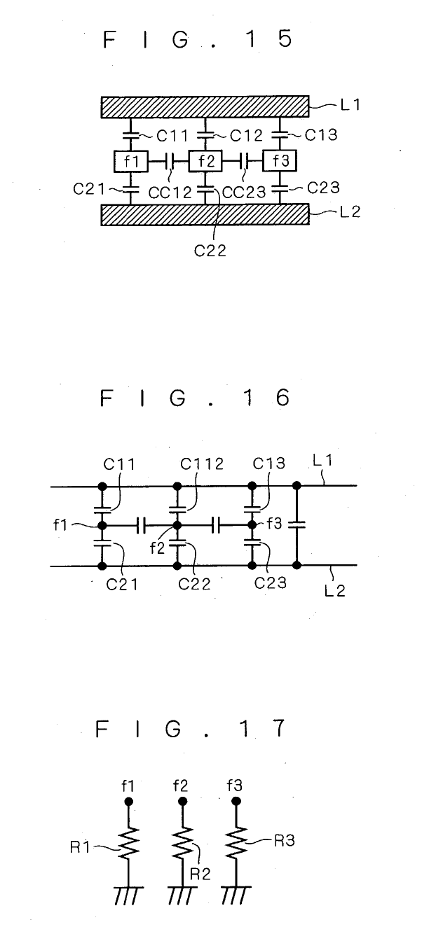

FIG. 15 is an illustrative example of the state in which parasitic capacitances are formed with the structure shown in FIG. 14. FIG. 16 is a circuit diagram illustrating an equivalent circuit between wiring elements L1 and L2 including the parasitic capacitances shown in FIG. 15. As shown in FIGS. 15 and 16, parasitic capacitances C11 to C13 are formed between the wiring element L1 and fill metal elements f1 to f3 (shown as nodes in FIG. 16), respectively, and parasitic capacitances C21 to C23 are formed between the wiring element L2 and fill metal elements f1 to f3, respectively. Also, a parasitic capacitance CC12 is formed between the fill metal elements f1 and f2, and a parasitic capacitance CC23 is formed between the fill metal elements f2 and f3.

As described, many parasitic capacitances are generated by inserting fill metals between interconnect lines, which gives rise to the disadvantage (1) as described above. A great number (several hundreds of thousands to millions) of fill metals are provided in several micrometers square in a position where the line density is low.

Thus, parasitic capacitances parasiting all of fill metals are extracted, and a circuit network including the fill metals together with the extracted parasitic capacitances are finally formed. When this circuit network is subjected to transient analysis by circuit simulations using SPICE or the like, the aforementioned disadvantage (1) becomes very serious.

FIG. 17 is an illustrative example of resistance interpolation of the fill metal elements. As shown, since the fill metal elements f1 to f3 have no path conducting to a ground level by direct current, transient analysis using SPICE or the like cannot be performed. To avoid this disadvantage, resistance R1 to R3 of high values are inserted between the fill metal elements f1 to f3 and the ground level, respectively. However, insertion of the resistances R1 to R3 causes the aforementioned disadvantage (2) that inflow and outflow of charges at the fill metals which actually do not exist degrades the accuracy of transient analysis. That is, insertion of resistances of high values between the fill metals and ground level causes parasitic capacitances to be estimated excessively greater than in an actual semiconductor integrated circuit, which disadvantageously hampers precise estimation of the accuracy of such actual semiconductor integrated circuit. Further, insertion of the resistances R1 to R3 increases the aforementioned disadvantage (1).

First Preferred Embodiment

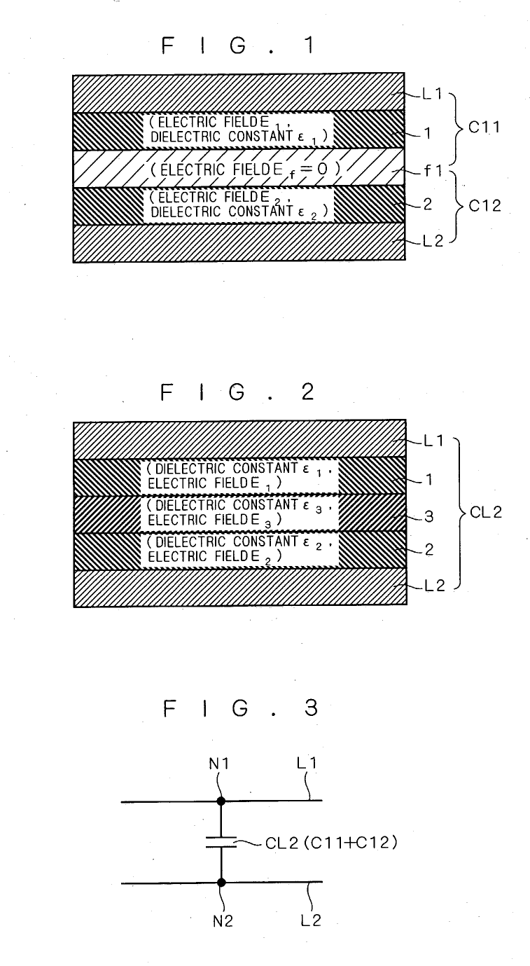

FIG. 1 is an illustrative example of the state of a parasitic capacitance between a fill metal part and interconnect lines. An insulation layer 1 is inserted between the fill metal element f1 and wiring element L1 and an insulation layer 2 is inserted between the fill metal element f1 and wiring element L2 so that the fill metal element f1 is isolated from the wiring elements L1 and L2.

Then, as explained in the description of the basic technique, the parasitic capacitance C11 is formed by the wiring element L1, insulation layer 1 and fill metal element f1, and the parasitic capacitance C12 is formed by the wiring element L2, insulation layer 2 and fill metal element f1. The insulation layers 1 and 2 have dielectric constants ε₁ and ε₂, respectively. Values of the parasitic capacitances C11 and C12 are determined by the dielectric constants ε₁, ε₂ and the like (For ease of description, the values of the parasitic capacitances C11 and C12 will briefly be called C11 and C12 hereinbelow). As a result, the value of a capacitance CL1 between the wiring elements L1 and L2 is indicated by (C11+C12). As has already been described, when inserting fill metals, resistances of high values are further inserted between the fill metals and ground level, causing the aforementioned disadvantage (2) to arise.

On the other hand, the fill metal element f1, made of a conductive wiring material, is equipotential in the inside thereof, and the degree of electric field E_{f} of the fill metal element f1 is “0”.

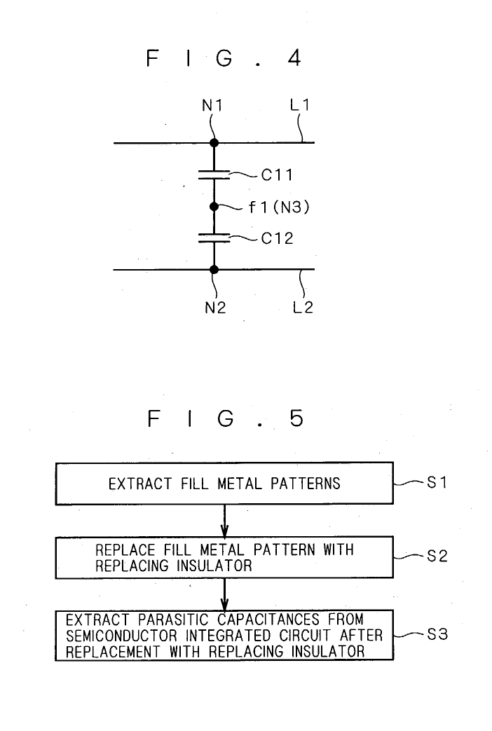

FIG. 2 is an illustrative example of fill metal replacement by a parasitic capacitance extracting method for a semiconductor integrated circuit according to the present embodiment. As shown, the fill metal f1 shown in FIG. 1 is replaced with a replacing insulator 3. As a result, in place of the parasitic capacitances C11 and C12, a parasitic capacitance CL2 in which the insulation layer 1, replacing insulator 3 and insulation layer 2 are inserted between the wiring elements L1 and L2 is formed.

The replacing insulator 3 has a dielectric constant ε₃ sufficiently greater than the dielectric constants ε₁ and ε₂ of the insulation layers 1 and 2 (a relative dielectric constant is not less than 100). The replacing insulator 3 has such a strong property of canceling out an electric field similarly to metal that the electric field E₃ in the replacing insulator 3 becomes approximately “0” because of storage of the electric flux density εE, whereby an electric field equivalent to one in the case where fill metals actually exist can be obtained.

That is, assuming that the insulation layers 1, 2 and 3 have the dielectric constants ε₁, ε₂ and ε₃, respectively, and the electric fields E₁, E₂ and E₃, respectively, the relations ε₁E₁=ε₂E₂=ε₃E₃ and ε₃>>ε₁, ε₂ hold, which allows the electric field E₃ to be approximately “0”.

As a result, as shown in an equivalent circuit of FIG. 3, after the fill metal element f1 is replaced with the replacing insulator 3, only the single parasitic capacitance CL2 is formed between nodes N1 and N2 of the wiring elements L1 and L2, and the capacitance value of the parasitic capacitance CL2 becomes (C11+C12).

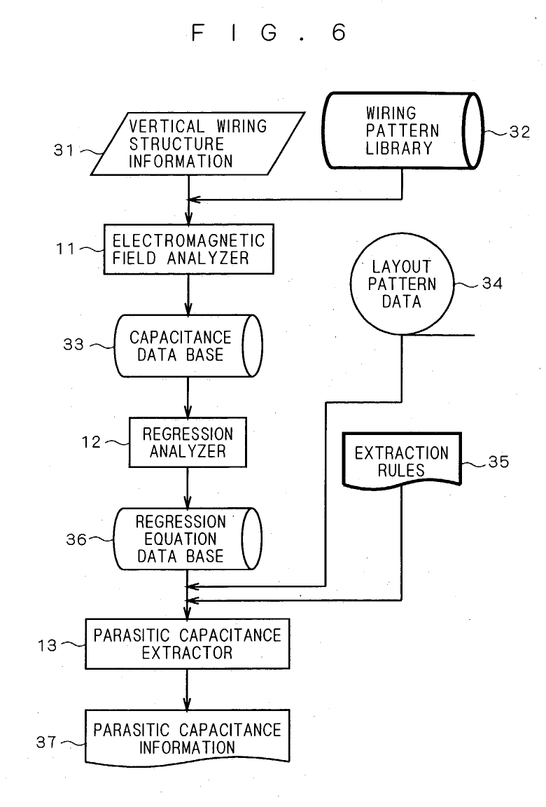

FIG. 4 is a circuit diagram illustrating an equivalent circuit formed by the parasitic capacitances C11 and C12 shown in FIG. 1. As shown, the parasitic capacitances C11 and C12 are connected in series between the nodes N1 and N2 of the wiring elements L1 and L2, and a node N3 between the parasitic capacitances C11 and C12 is the fill metal element f1.

As is apparent from comparison between FIGS. 3 and 4, the circuits are equivalent to each other. Further, since the fill metal element f1 is replaced with the replacing insulator 3 and becomes nonexistent, the number of parasitic capacitances can be reduced from two to one, and the number of nodes can also be reduced from three to two.

Further, the resistances of high values as shown in FIG. 17 does not need to be inserted in the structure after the replacement with the replacing insulator 3, which improves the accuracy of circuit analysis.

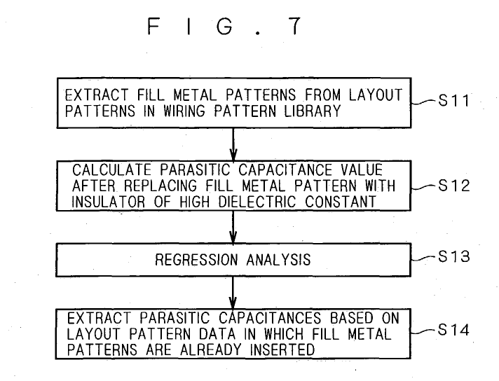

FIG. 5 is a flow chart illustrating the parasitic capacitance extracting method for a semiconductor integrated circuit according to the present embodiment.

Referring to FIG. 5, at step S1, fill metal patterns (dummy wiring patterns) are extracted from information such as a layout pattern that specifies a semiconductor integrated circuit. Then, at step S2, an extracted fill metal pattern is replaced with the replacing insulator 3. Thereafter, at step S3, values of parasitic capacitances parasiting the replacing insulator 3 are extracted based on the semiconductor integrated circuit after the replacement with the replacing insulator 3.

As described, in the present embodiment, parasitic capacitances (values) are extracted from the semiconductor integrated circuit in which a fill metal patterns is replaced with the replacing insulator 3, allowing the number of parasitic capacitances and that of nodes to be greatly reduced as above described, which hence allows circuit analysis time including analysis time of parasitic capacitances to be greatly shortened. Further, since the equivalency of the semiconductor integrated circuit before and after the replacement with the replacing insulator 3 is maintained, the accuracy of circuit analysis including parasitic capacitance analysis is not degraded.

Second Preferred Embodiment

FIG. 6 is a block diagram illustrating the structure of a parasitic capacitance extracting device for a semiconductor integrated circuit according to a second preferred embodiment of the invention.

As shown, an electromagnetic field analyzer 11 receives vertical wiring structure information 31 and information of a wiring pattern library 32.

A wide variety of wiring patterns are previously stored in the wiring pattern library 32. Such wiring patterns include fill metal patterns models. The vertical wiring structure information 31 is information that specifies the vertical structure of interconnect lines in an actual manufacturing process, such as the thicknesses of respective wiring layers used in the semiconductor integrated circuit from which parasitic capacitances are to be extracted and the dielectric constants of interlayer insulation layers made of, e.g., an oxide film.

Examples of the vertical wiring structure information 31 and wiring pattern library 32 will be described in reference to FIG. 14. Stored in the pattern library 32 are a variety of combinations of a first-layer wiring pattern including the wiring element L2, a second-layer wiring pattern including the fill metal elements f1 to f3 and a third-layer wiring pattern including the wiring element L1. Also, information for distinguishing between normal wiring patterns and fill metal patterns is added. On the other hand, the information 31 represents information such as the thicknesses of the wiring elements L1, L2 and fill metal elements f1 to f3, and the thickness and dielectric constant of an interlayer insulation film between the wiring elements L1, L2 and fill metal elements f1 to f3.

Therefore, the electromagnetic field analyzer 11 can precisely recognize the three-dimensional structure of wiring patterns including fill metal patterns based on the vertical wiring structure information 31 and information received from the wiring pattern library 32.

That is, the electromagnetic field analyzer 11 performs electromagnetic analysis based on the vertical wiring structure information 31 and information received from the wiring pattern library 32 to replace a fill metal pattern with an insulator of high dielectric constant, thereby finally storing, in a capacitance value data base 33, parasitic capacitance value information in which values of parasitic capacitances parasiting the insulator of high dielectric constant obtained by replacing the fill metal pattern with the insulator are in correspondence with fill metal patterns (models) in the pattern library 32. In this way, the analyzer 11 functions as means for calculating parasitic capacitance value information.

For instance, when the three-dimensional structure of the wiring elements L1, L2 and fill metal elements f1 to f3 as shown in FIG. 14 is recognized, parasitic capacitance value information is generated by the electromagnetic field analyzer 11 bringing the value of the parasitic capacitance CL2 as shown in FIG. 3 into correspondence with the three-dimensional layout structure shown in FIG. 14.

A regression analyzer 12 performs regression analysis based on the parasitic capacitance value information stored in the capacitance value data base 33, thereby storing, in a regression equation data base 36, regression equation information for deriving parasitic capacitance values from (model) size information obtained from fill metal patterns and associated wiring patterns such as wiring length, wiring width, wiring spacing and the like.

A parasitic capacitance extractor 13 receives layout pattern data 34, extraction rules 35 and regression equation information in the regression equation data base 36.

The layout pattern data 34 is data that specifies a layout pattern of a semiconductor integrated circuit including fill metal patterns from which parasitic capacitances are to be extracted. The extraction rules 35 specify circuit connection information that corresponds to the layout pattern specified by the layout pattern data 34 and rules for extracting fill metal patterns. That is, the extraction rules 35 specify, as circuit information, the position of connection pins (input/output pins), wiring information, and the position, size, configuration, type, etc. of respective components of the semiconductor integrated circuit. Such components include devices, metal layers (wiring layers), via holes and the like. The extraction rules 35 further specify rules for extracting fill metal patterns based on the circuit connection information.

The parasitic capacitance extractor 13 obtains values of parasitic capacitances parasiting the replacing insulator for outputting parasitic capacitance information 37 while extracting fill metal patterns based on the layout pattern data 34 and extraction rules 35 and applying a regression equation of the regression equation information to size information such as the wiring width, wiring spacing, etc. of patterns associated with the fill metal patterns. The processing performed by the parasitic capacitance extractor 13 is achieved, for example, by executing a program by a computer or the like.

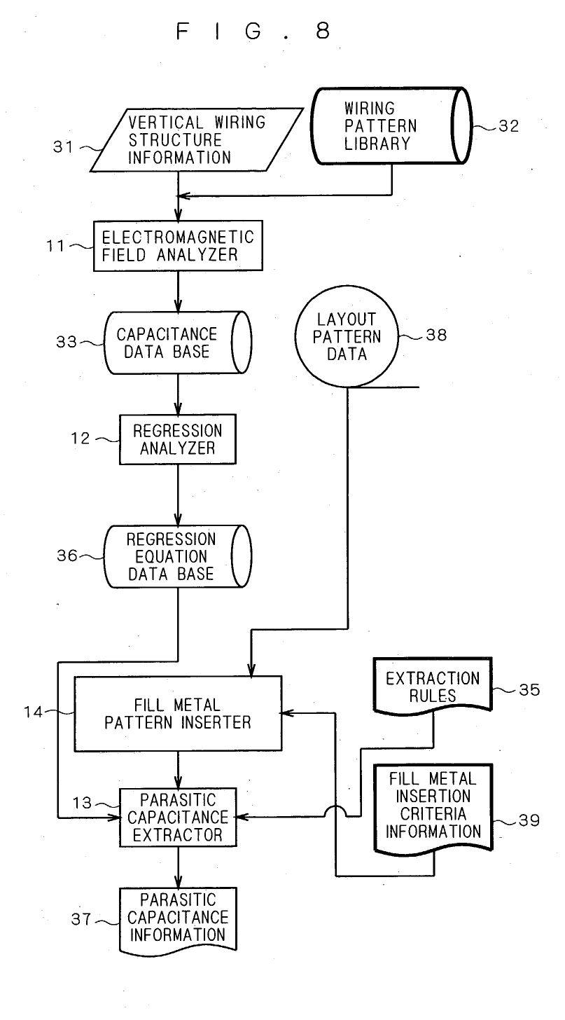

FIG. 7 is a flow chart illustrating parasitic capacitance extraction performed by the parasitic capacitance extracting device according to the present embodiment.

First, at step S11, the electromagnetic field analyzer 11 performs electromagnetic analysis in accordance with a predetermined electromagnetic algorithm based on the vertical wiring structure information 31 and the layout pattern registered in the wiring pattern library 32, thereby extracting patterns such as fill metal patterns in which the degree of electric field is “0”. For instance, the fill metal elements f1 to f3 shown in FIG. 14 correspond to extracted fill metal patterns (models).

Then, at step S12, the electromagnetic field analyzer 11 replaces a fill metal pattern (model) with the insulator of high dielectric constant. Parasitic capacitance values in a layout pattern after the replacement are calculated and registered in the capacitance value data base 33. In the wiring pattern library 32, a wide variety of wiring patterns are registered. For instance, in the example of FIG. 14, a wide variety of wiring patterns are registered with variations in the respective wiring widths and wiring lengths of the wiring elements L1, L2 and fill metal elements f1 to f3, and the spacing between the fill metal elements f1 and f2 and that between the fill metal elements f2 and f3, and the like. Parasitic capacitance values are obtained in correspondence with respective fill metal patterns (models) among the wide variety of wiring patterns.

Thereafter, at step S13, the regression analyzer 12 performs regression analysis based on the parasitic capacitance values obtained from the capacitance value data base 33 to obtain a regression equation based on (model) size information including the influence caused by the multilayer interconnection, the influence caused by the configuration, size, position of interconnect lines and the like, thereby registering the regression equation information in the regression equation data base 36.

Next, at step S14, upon receipt of the layout pattern data 34 in which fill metal patterns are already inserted, extraction rules 35 and regression equation information from regression equation data base 36, the parasitic capacitance extractor 13 extracts fill metal patterns from the layout pattern data 34 based on the extraction rules 35 for obtaining the parasitic capacitance information 37 including parasitic capacitance values by appropriately applying regression equation information to size information of patterns associated with the extracted fill metal patterns. As a result, parasitic capacitances parasiting the insulator and parasitic capacitance values thereof can be obtained in correspondence with the extracted fill metal patterns.

As described, in the present embodiment, the parasitic capacitances (values) are finally extracted from the semiconductor integrated circuit in which fill metal patterns are each replaced with the replacing insulator. This allows circuit analysis time including time for analyzing the parasitic capacitances to be greatly shortened, similarly to the first preferred embodiment.

In addition to the above effect as in the first preferred embodiment, the present embodiment brings the following advantage. That is, the parasitic capacitance extractor 13 obtains the size information associated with the fill metal patterns based on the Layout pattern data 34 and extraction rules 35, and extracts parasitic capacitance values that correspond to layout partial information referring to the (model) size information in the regression equation information. Thus, pattern matching is not required, which allows parasitic capacitance values to be extracted with high speed.

Further, since fill metal patterns are already inserted in the layout pattern data 34, processing time can be shortened by the time for inserting fill metal patterns into the layout pattern.

Third Preferred Embodiment

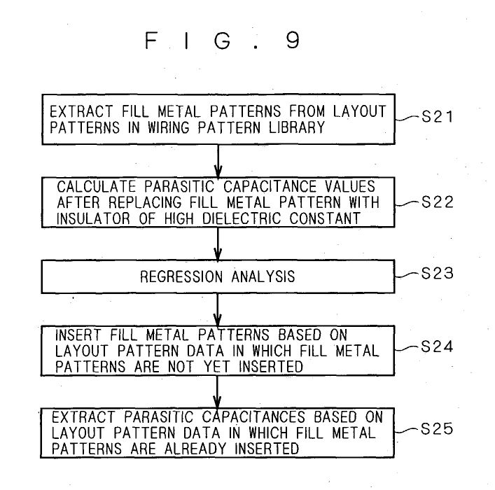

FIG. 8 is a block diagram illustrating the structure of a parasitic capacitance extracting device for a semiconductor integrated circuit according to a third preferred embodiment of the invention. Those parts corresponding to the components of FIG. 6 are identified with the same reference numerals, a repeated explanation of which will be omitted.

As shown in FIG. 8, a fill metal pattern inserter 14 receives layout pattern data 38 in which fill metal patterns are not yet inserted and fill metal insertion criteria information 39. The information 39 includes information that specifies fill metal insertion criteria such as the configuration, size, spacing, type, etc. of fill metal patterns. The layout pattern data 38 represents data obtained by excluding data specifying fill metal patterns from the layout pattern data 34 used in the second preferred embodiment.

The fill metal pattern inserter 14 calculates the wiring pattern density based on the layout pattern data 38, then extracts fill metal insertion criteria that matches the wiring pattern density from the fill metal insertion criteria information 39, thereby obtaining data in which fill metal patterns are inserted based on the extracted fill metal insertion criteria. As a result, fill metal patterns are additionally inserted in the layout pattern data 38 in which fill metal patterns are not yet inserted, whereby the layout pattern data 38 becomes equivalent to the layout pattern data 34 in which fill metal patterns are already inserted.

The parasitic capacitance extractor 13 outputs the parasitic capacitance information 37 based on the layout pattern data 38 in which fill metal patterns are additionally inserted by the fill metal pattern inserter 14, extraction rules 35 and regression equation data base 36, similarly to the second preferred embodiment. Other components are the same as those in the second preferred embodiment, explanation of which is thus omitted here.

FIG. 9 is a flow chart illustrating parasitic capacitance extraction performed by the parasitic capacitance extracting device according to the present embodiment.

Steps S21 to S23 are the same as steps S11 to S13 according to the second preferred embodiment shown in FIG. 7, explanation of which is thus omitted here.

At step S24, the fill metal pattern inserter 14 additionally inserts fill metal patterns in the layout pattern data 38 based on the layout pattern data 38 in which fill metal patterns are not yet inserted and fill metal insertion criteria information 39.

Next, at step S25, upon receipt of the layout pattern data 38 in which fill metal patterns have been added, extraction rules 35 and regression equation information from the regression equation data base 36, the parasitic capacitance extractor 13 extracts fill metal patterns from the layout pattern data 38 based on the extraction rules 35, and obtains the parasitic capacitance information 37 including parasitic capacitance values by appropriately applying the regression equation information to size information of patterns associated with the extracted fill metal patterns.

In addition to the above effect as in the first preferred embodiment, the present embodiment brings the following advantage. That is, upon receipt of the layout pattern data 38 in which fill metal patterns are not yet inserted and the fill metal insertion criteria information 39, the fill metal pattern inserter 14 additionally inserts fill metal patterns in the layout pattern data 38 based on the fill metal insertion criteria information 39. This eliminates the necessity to prepare in advance layout pattern data in which fill metal patterns are already inserted (corresponding to the layout pattern data 34), which allows reduction of time and effort to generate layout pattern data.

Further, similarly to the second preferred embodiment, the advantage can be achieved in that parasitic capacitance values can be extracted with high speed by referring to the regression equation information of the regression equation data base 36.

Fourth Preferred Embodiment

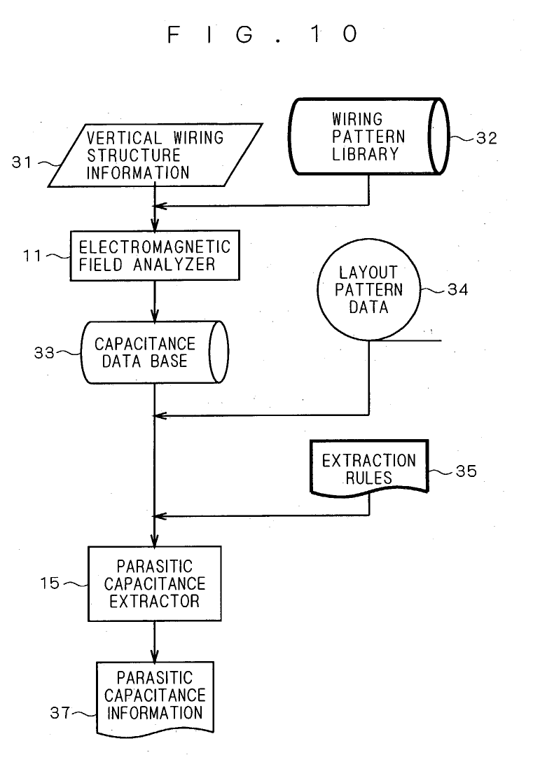

FIG. 10 is a block diagram illustrating the structure of a parasitic capacitance extracting device for a semiconductor integrated circuit according to a fourth preferred embodiment of the invention. Those parts corresponding to the components of FIG. 6 are identified with the same reference numerals, a repeated explanation of which will be omitted.

As shown in FIG. 10, a parasitic capacitance extractor 15 receives the layout pattern data 34 in which fill metal patterns are already inserted, capacitance value data base 33 and extraction rules 35. The extractor 15 recognizes fill metal patterns parasited by parasitic capacitances (and associated wiring patterns) by means of the layout pattern data 34 and extraction rules 35, and performs pattern matching between the recognized fill metal patterns and fill metal pattern models registered in the capacitance value data base 33 (and associated wiring patterns). Then, the extractor 15 extracts parasitic capacitance values that correspond to fill metal patterns matched in the pattern matching from the capacitance value data base 33, thereby obtaining the parasitic capacitance information 37. Other components are the same as those in the second preferred embodiment, explanation of which is thus omitted here.

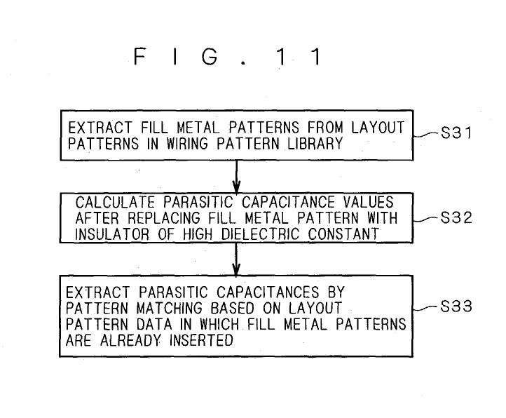

FIG. 11 is a flow chart illustrating parasitic capacitance extraction performed by the parasitic capacitance extracting device according to the present embodiment.

Steps S31 and S32 are the same as steps S11 and S12 according to the second preferred embodiment shown in FIG. 7, explanation of which is thus omitted here.

At step S33, as described above, the parasitic capacitance extractor 15 performs pattern matching based on the capacitance value data base 33, layout pattern data 34 and extraction rules 35, thereby obtaining parasitic capacitance information 37 including parasitic capacitance values.

In addition to the above effect as in the first preferred embodiment, the present embodiment brings the following advantage. That is, the parasitic capacitance extractor 15 performs pattern matching between the fill metal patterns extracted based on the layout pattern data 34 and extraction rules 35 and fill metal pattern models that correspond to parasitic capacitance values in the capacitance value data base 33, and extracts parasitic capacitance values based on the result of pattern matching. Thus, the parasitic capacitance values can be extracted with high accuracy.

Further, since fill metal patterns are already inserted in the layout pattern data 34, processing time can be shortened by the time for inserting fill metal patterns into the layout pattern.

Fifth Preferred Embodiment

FIG. 12 is a block diagram illustrating the configuration of a parasitic capacitance extracting device for a semiconductor integrated circuit according to a fifth preferred embodiment of the invention. Those parts corresponding to the components of FIG. 8 or 10 are identified with the same reference numerals, a repeated explanation of which will be omitted.

As shown in FIG. 12, similarly to the third preferred embodiment, the fill metal pattern inserter 14 calculates the wiring pattern density based on the layout pattern data 38 in which fill metal patterns are not yet inserted, then extracts fill metal insertion criteria that match the wiring pattern density from the fill metal insertion criteria information 39, thereby additionally inserting fill metal patterns in the layout pattern data 38 based on the extracted fill metal insertion criteria.

Similarly to the fourth preferred embodiment, the parasitic capacitance extractor 15 receives the layout pattern data 38 in which fill metal patterns are additionally inserted, capacitance value data base 33 and extraction rules 35. The extractor 15 recognizes fill metal patterns parasited by parasitic capacitances by means of the layout pattern data 38, the fill metal patterns added thereto and extraction rules 35, and performs pattern matching between the recognized fill metal patterns and the fill metal pattern models registered in the capacitance value data base 33. Then, the extractor 15 extracts parasitic capacitance values that correspond to fill metal patterns matched in the pattern matching from the capacitance value data base 33, thereby obtaining the parasitic capacitance information 37. Other components are the same as those in the second preferred embodiment, explanation of which is thus omitted here.

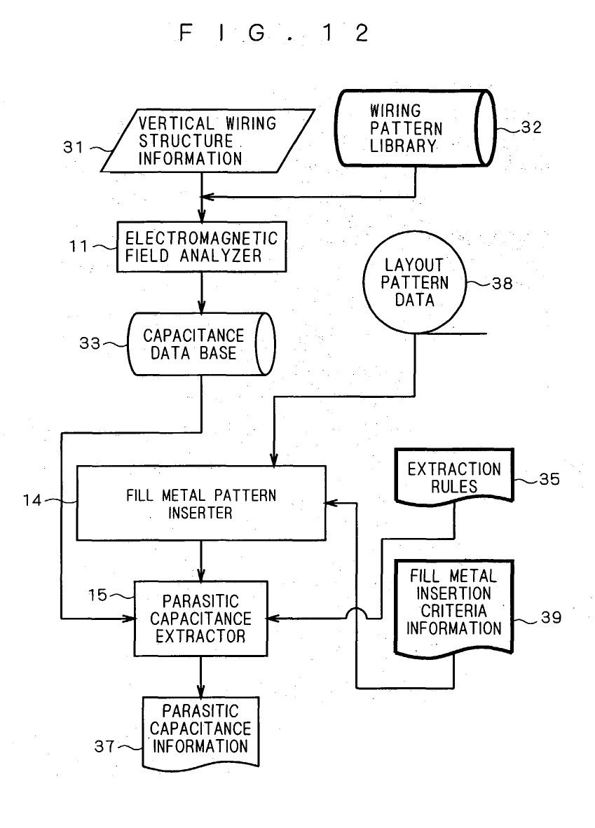

FIG. 13 is a flow chart illustrating parasitic capacitance extraction performed by the parasitic capacitance extracting device according to the present embodiment.

Steps S41 and S42 are the same as steps S11 and S12 according to the second preferred embodiment shown in FIG. 7, explanation of which is thus omitted here.

At step S43, the fill metal pattern inserter 14 additionally inserts fill metal patterns in the layout pattern data 38 based on the layout pattern data 38 in which fill metal patterns are not yet inserted and fill metal insertion criteria information 39.

At step S44, as described above, the parasitic capacitance extractor 15 performs pattern matching based on the capacitance value data base 33, layout pattern data 38, the fill metal patterns added at step S43 and extraction rules 35, thereby obtaining the parasitic capacitance information 37 including parasitic capacitance values.

In addition to the above effect as in the first preferred embodiment, the present embodiment brings the following advantage. That is, similarly to the third preferred embodiment, the fill metal pattern inserter 14 additionally inserts fill metal patterns in the layout pattern data 38, which allows reduction of time and effort to generate layout pattern data.

Further, similarly to the fourth preferred embodiment, the parasitic capacitance extractor 15 performs pattern matching between fill metal patterns and the fill metal pattern models that correspond to parasitic capacitance values in the capacitance value data base 33, which allows the parasitic capacitance values to be extracted with high accuracy.

While the invention has been shown and described in detail, the foregoing description is in all aspects illustrative and not restrictive. It is therefore understood that numerous modifications and variations can be devised without departing from the scope of the invention.

What is claimed is:

1. A parasitic capacitance extracting device for a semiconductor integrated circuit, comprising:
a parasitic capacitance value information calculator configured to extract a dummy wiring pattern model from a wiring pattern library specifying wiring patterns of multilayer structure including said dummy wiring pattern model to replace said dummy wiring pattern model with a replacing insulator, thereby obtaining parasitic capacitance value information in which a value of a parasitic capacitance parasiting said replacing insulator is in correspondence with said dummy wiring pattern model, said replacing insulator having a dielectric constant higher than that of an interlayer insulation film isolating a wiring pattern of another layer from said dummy wiring pattern model; and
a parasitic capacitance extractor configured to receive layout pattern data specifying a semiconductor integrated circuit from which a parasitic capacitance is to be extracted and an extraction rule for extracting a dummy wiring pattern and to extract said dummy wiring pattern from said layout pattern data, thereby extracting a parasitic capacitance value corresponding to said dummy wiring pattern as extracted based on information related to said parasitic capacitance value information.

2. The parasitic capacitance extracting device according to claim 1, further comprising
a regression analyzer configured to perform regression analysis on said parasitic capacitance value information to obtain regression equation information in which model size information specifying a size related to said dummy wiring pattern model is in correspondence with said parasitic capacitance value, wherein
said parasitic capacitance extractor includes an extractor for obtaining size information related to said dummy wiring pattern based on said layout pattern data and said extraction rule, thereby extracting a parasitic capacitance value corresponding to said size information referring to said model size information of said regression equation information.

3. The parasitic capacitance extracting device according to claim 1, wherein
said parasitic capacitance extractor includes an extractor for obtaining said dummy wiring pattern based on said layout pattern data and said extraction rule and performing pattern matching between said dummy wiring pattern and said dummy wiring pattern model in said parasitic capacitance value information, thereby extracting a parasitic capacitance value based on the result of pattern matching.

4. The parasitic capacitance extracting device according to claim 1, wherein
said layout pattern data is inputted to said parasitic capacitance extractor as layout pattern data in which said dummy wiring pattern is already inserted.

5. The parasitic capacitance extracting device according to claim 1, further comprising
a dummy wiring pattern inserter configured to receive layout pattern data in which said dummy wiring pattern is not yet inserted and dummy wiring pattern insertion criteria information specifying insertion criteria of said dummy wiring pattern, thereby inserting said dummy wiring pattern in said layout pattern in which said dummy wiring pattern is not yet inserted based on said dummy wiring pattern insertion criteria information, wherein
said parasitic capacitance extractor receives said layout pattern data in which said dummy wiring pattern is inserted by said dummy wiring pattern inserter.

6. A parasitic capacitance extracting method for a semiconductor integrated circuit, comprising the steps of:
(a) receiving layout pattern data specifying a layout structure of a semiconductor integrated circuit from which a parasitic capacitance is to be extracted, thereby extracting said dummy wiring pattern from said layout pattern data, said layout pattern data including a wiring pattern of multilayer structure and a dummy wiring pattern;
(b) replacing said dummy wiring pattern with a replacing insulator, said replacing insulator having a dielectric constant higher than that of an interlayer insulation film isolating a wiring pattern of another layer from said dummy wiring pattern; and
(c) extracting a value of a parasitic capacitance parasiting said replacing insulator based on a circuit specified by said layout pattern data after replacement with said replacing insulator.
